(19) United States
(12) Patent Application Publication
(10) Pub. No.: US 2016/0304113 A1
(43) Pub. Date: Oct. 20, 2016

(54) STEERING COLUMN FOR MACHINE

(71) Applicant: Caterpillar Inc., Peoria, IL (US)

(72) Inventor: Alexander S. McCurdy, Clayton, NC (US)

(73) Assignee: Caterpillar Inc., Peoria, IL (US)

(21) Appl. No.: 15/193,255

(22) Filed: Jun. 27, 2016

(51) Int. Cl. B62D 1/189; B62D 1/04

(52) U.S. Cl. CPC B62D 1/189; B62D 1/04

(57) ABSTRACT

A steering column for a machine is disclosed. The steering column includes a base portion coupled to a floor panel disposed within an operator cabin of the machine. The steering column also includes a first portion coupled to the base portion by a first pivot joint. The first portion is movable between a first position and a second positon with respect to the floor panel about a first pivot axis. The steering column further includes a second portion coupled to the first portion by a second pivot joint and a steering wheel. The second portion is movable between a third position and a fourth position with respect to the first portion about a second pivot axis. The second pivot axis is perpendicular to the first pivot axis.

### TECHNICAL FIELD

The present disclosure relates to a steering system of a machine, and more specifically to a steering column disposed in an operator cabin of the machine.

### BACKGROUND

Machines, such as mini hydraulic excavators, include an operator cabin for enclosing various components, such as a steering column, a steering wheel, an operator seat, a joystick, and other control levers. Also, the operator cabin accommodates an operator for controlling various operations of the machine using the components, such as the steering wheel and the joystick. Dimensional specification of the operator cabin, positioning of the steering column, the operator seat, and the joystick in the operator cabin may vary based on a size of the machine. In an example, the mini hydraulic excavator may have a smaller size operator cab. In such an operator cab, components, such as the steering wheel, the operator seat, and the joystick, are disposed in close proximity to each other. Especially, a clearance provided between the steering wheel, and the joystick and other control levers disposed in the sides of the operator seat may hinder ingress and egress of the operator into the operator cabin of the mini hydraulic excavator. Further, the joystick or the control levers may displace from its original position, if the operator inadvertently hits the joystick or the control levers, while entering into or exiting the operator cabin. This might leads to an undesirable operation of the machine.

European Patent Number 0841236, hereinafter referred to as “the '236 patent”, describes a steering column, which is capable of moving four ways. The steering column has a base support affixed to a horizontal cab floor. The steering column has an input shaft with an upper telescoping shaft. Attached to the upper telescoping shaft is the steering wheel. Also attached to the upper telescoping shaft is the upper input shaft. The first universal joint connects the upper input shaft to the inner input shaft. The outer input shaft is connected to the lower input shaft by the second universal joint. Attached to the base support is the lower pivot assembly. The lower pivot assembly pivots about the base support by actuating a lower gas cylinder. The lower pivot assembly can translate by operating the lower locking knob. The upper pivot assembly is attached to the lower pivot assembly. The upper pivot assembly can pivot by actuating an upper gas cylinder. While the steering column of the '236 patent proposes to improve the operator visibility, however, it does not effectively eliminate the problem associated with ingress and egress of an operator in a cab.

### SUMMARY OF THE DISCLOSURE

In one aspect of the present disclosure, a steering column for a machine is provided. The steering column includes a base portion coupled to a floor panel disposed within an operator cabin of the machine. The steering column also includes a first portion coupled to the base portion by a first pivot joint. The first portion is movable between a first position and a second positon with respect to the floor panel about a first pivot axis. The steering column further includes a second portion coupled to the first portion by a second pivot joint and a steering wheel. The second portion is movable between a third position and a fourth position with respect to the first portion about a second pivot axis. The second pivot axis is perpendicular to the first pivot axis.

Other features and aspects of this disclosure will be apparent from the following description and the accompanying drawings.

### BRIEF DESCRIPTION OF THE DRAWINGS

FIG. 1 is a side view of a machine having an operator cabin;

FIG. 2 is a schematic side view of the operator cabin having a steering column disposed therein;

FIG. 3 is a schematic perspective view of the steering column of FIG. 2;

FIG. 4 is a schematic side view of the operator cabin of FIG. 2 showing movement of the steering column about a first pivot joint;

FIG. 5 is a schematic front view of the operator cabin of FIG. 2 showing movement of the steering column about a second pivot joint; and

FIG. 6 is a schematic top view of the operator cabin of FIG. 2 showing a first clearance between an operator seat and a steering wheel, and a second clearance between the steering wheel and a joystick.

### DETAILED DESCRIPTION

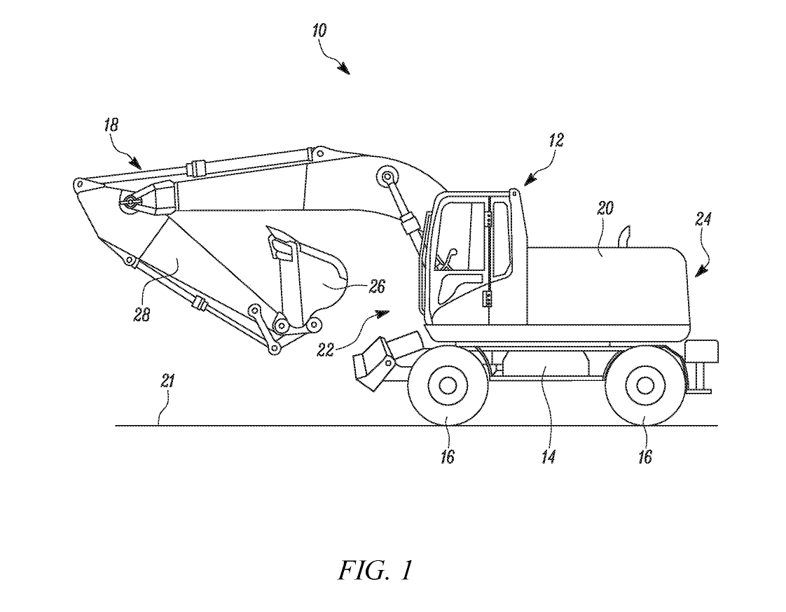

FIG. 1 is a side view of an exemplary machine 10 having an operator cabin 12, A wheel type mini hydraulic excavator is shown in FIG. 1 for illustration purpose of the present disclosure. However, it may be understood that the machine 10 may be a mobile machine used in various industries, such as mining, construction, farming, transportation, or any other industry known in the art. For example, the machine 10 may be an earth moving machine, such as a backhoe, a dozer, a loader, and a motor grader.

The machine 10 includes a frame 14, and a number of ground engaging members 16, such as wheels supported on the frame 14 for propelling the machine 10. The machine 10 further includes an implement system 18 coupled to the frame 14 for performing various earth moving operations, and a compartment 20 for accommodating a power source (not shown), such as an engine. The machine 10 also includes the operator cabin 12 for accommodating an operator (not shown). The ground engaging members 16 are in contact with a work surface 21 for moving the machine 10 over the work surface 21. The ground engaging members 16 are disposed at a front end 22 and a rear end 24 of the machine 10. In one example, the ground engaging members 16 may include a pair of tracks for moving the machine 10 over the work surface 21. The implement system 18 is disposed at the front end 22 of the machine 10. The implement system 18 includes a bucket 26 pivotally coupled to a linkage member 28. The linkage member 28 is connected to the frame 14 of the machine 10. In other examples, the implement system 18 may include, but is not limited to, an auger, a blade, a hammer, and a ripper.

The power source is accommodated in the compartment 20 at the rear end 24 of the machine 10. The power source is provided for generating power to propel the machine 10 and to operate the implement system 18. In an example, the power source may produce a mechanical power output or an electrical power output that may further be converted to a hydraulic power for operating the implement system 18. The operator cabin 12 is mounted on the frame 14 at the front end 22 of the machine 10. The operator cabin 12 accommodates the operator to control operations of the machine 10 and the implement system 18.

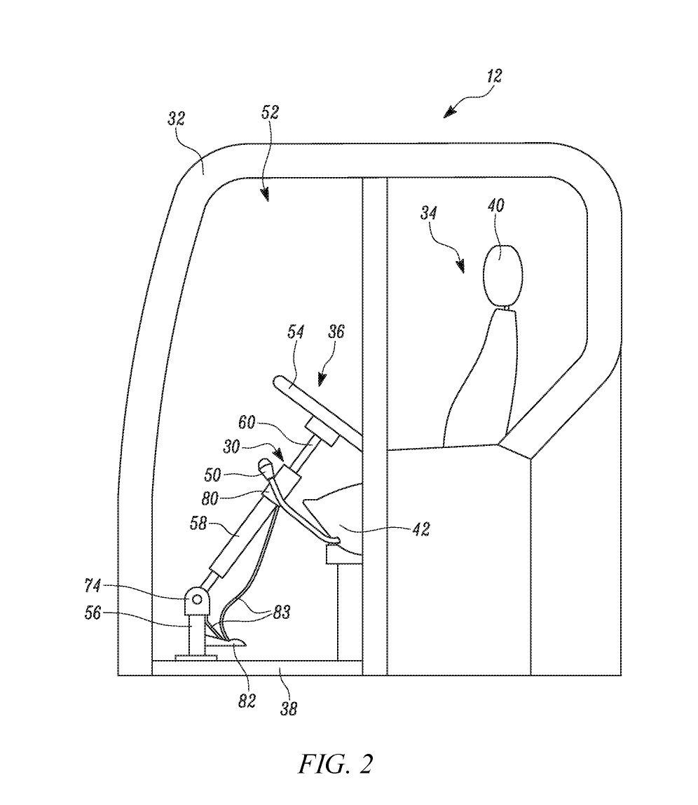

Referring to FIGS. 1 and 2, the operator cabin 12 includes a cabin frame 32, a seat unit 34, and a steering system 36. In an example, the operator cabin 12 may include a number of operator controls (not shown) for performing various operations such as, a loading operation, a dumping operation, an excavating operation, or any other earthmoving operations known in the art. The operator controls may include, but are not limited to, push-buttons, control levers, and control pedals.

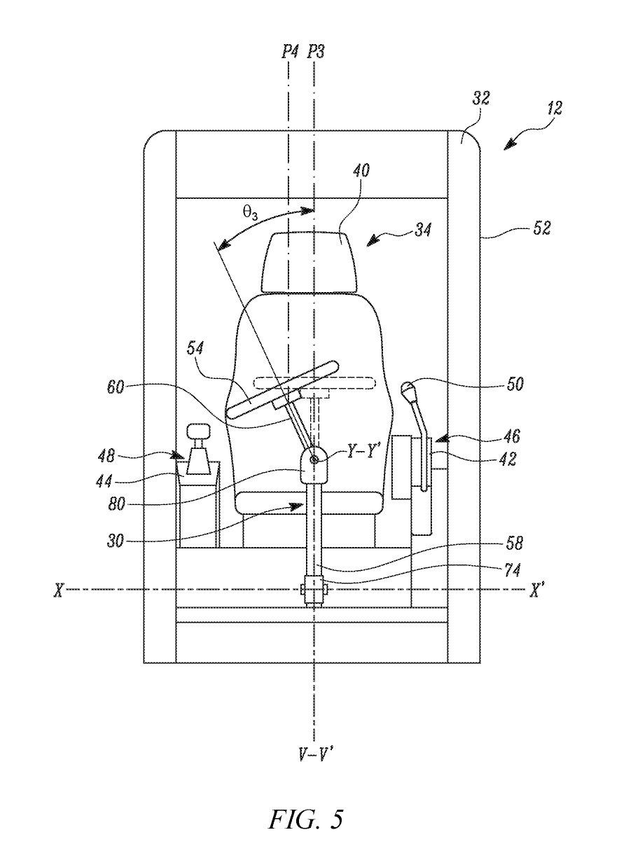

A floor panel 38 is disposed within the operator cabin 12 of the machine 10. More specifically, the cabin frame 32 of the operator cabin 12 includes the floor panel 38 supported on the frame 14 of the machine 10. The seat unit 34 is mounted on the floor panel 38 of the cabin frame 32. The seat unit 34 includes an operator seat 40, a first seat console 42, and a second seat console 44 (shown in FIG. 5). The first seat console 42 and the second seat console 44 are disposed on a first side 46 (shown in FIG. 5) and a second side 48 (shown in FIG. 5) of the operator seat 40, respectively. The first seat console 42 includes a joystick 50 for controlling various operations of the machine 10 and/or the implement system 18. Further, the operator cabin 12 has a doorway 52 disposed at the first side 46 of the operator seat 40. The doorway 52 assists the operator to enter into and exit from the operator cabin 12.

The steering system 36 includes a steering column 30 mounted on the floor panel 38 of the cabin frame 32. The steering column 30 is positioned proximal to the operator seat 40. The steering system 36 also includes a steering wheel 54 coupled to the steering column 30. The steering wheel 54 assists the operator to control a direction of movement of the machine 10 over the work surface 21.

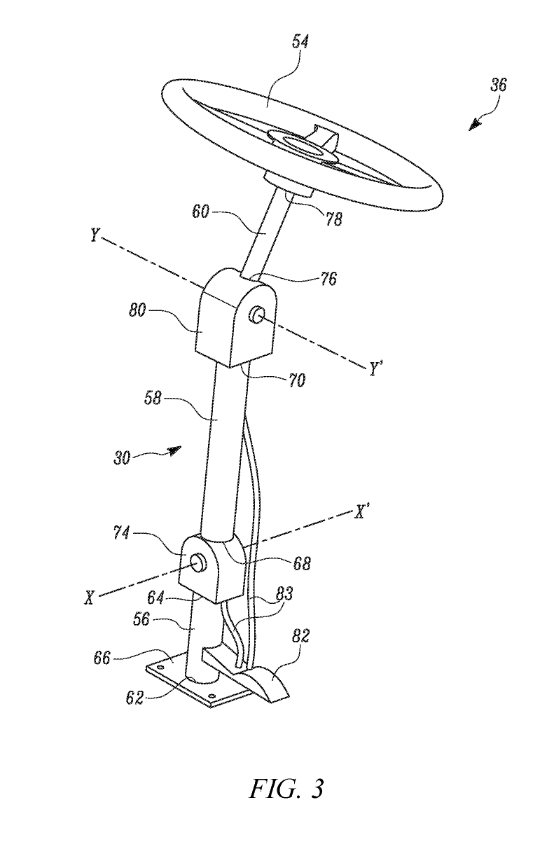

Referring to FIGS. 2 and 3, the steering column 30 includes a base portion 56, a first portion 58 connected to the base portion 56, and a second portion 60 connected to the first portion 58, The base portion 56 is coupled to the floor panel 38 of the operator cabin 12. In the illustrated example, the base portion 56 includes a first end 62 and a second end 64. The first end 62 includes a mounting member 66 for coupling the base portion 56 to the floor panel 38 of the operator cabin 12. The mounting member 66 may be fastened to the floor panel 38 by fastening members (not shown), thereby rigidly connecting the base portion 56 to the floor panel 38. The second end 64 of the base portion 56 is coupled to the first portion 58 of the steering column 30. In another example, the base portion 38 may be a mounting plate (not shown) for pivotally connecting the first portion 58 to the floor panel 38 of the operator cabin 12.

The first portion 58 includes a third end 68 and a fourth end 70. The third end 68 is coupled to the second end 64 of the base portion 56 of the steering column 30. More specifically, the third end 68 of the first portion 58 is pivotally coupled to the second end 64 of the base portion 56. Further, the steering column 30 includes a first pivot joint 74 defined between the second end 64 of the base portion 56 and the third end 68 of the first portion 58. In another example, the first pivot joint 74 may be connected to the floor panel 38 for allowing pivotal movement of the first portion 58 with respect to the floor panel 38. The first pivot joint 74 allows movement of the first portion 58 about a first pivot axis X-X′ with respect to the floor panel 38. The fourth end 70 of the first portion 58 is coupled to the second portion 60 of the steering column 30.

The second portion 60 includes a fifth end 76 and a sixth end 78. The fifth end 76 is coupled to the fourth end 70 of the first portion 58. More specifically, the fifth end 76 of the second portion 60 is pivotally connected to the fourth end 70 of the first portion 58. The sixth end 78 is connected to the steering wheel 54 of the steering system 36. Further, the steering column 30 includes a second pivot joint 80 defined between the fourth end 70 of the first portion 58 and the fifth end 76 of the second portion 60. The second pivot joint 80 allows movement of the second portion 60 about a second pivot axis Y-Y′ with respect to the first portion 58 of the steering column 30. The second pivot axis Y-Y′ is perpendicular to the first pivot axis X-X′.

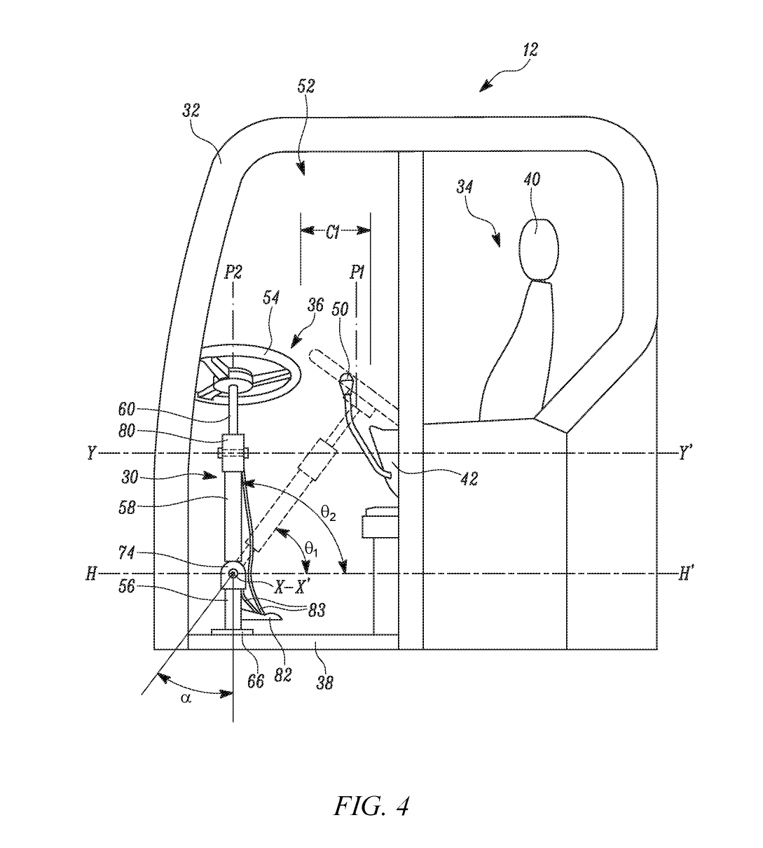

FIG. 4 illustrates a schematic side view of the operator cabin 12 showing a movement of the steering column 30 about the first pivot joint 74. Referring to FIGS. 3 and 4, the base portion 56 of the steering column 30 includes a foot pedal 82. The foot pedal 82 is operably connected to the first pivot joint 74 and the second pivot joint 80 by a pair of cables 83. In an example, each of the first pivot joint 74 and the second pivot joint 80 may include a locking mechanism, such as a ratchet and pawl mechanism, connected to the cables 83. in such an example, the cables 83 actuates the locking mechanism, thereby allowing or restricting movement of the first portion 58 and the second portion 60 about the first pivot joint 74 and the second pivot joint 80, respectively. The foot pedal 82 is provided to control the movement of the steering column 30 about the first pivot joint 74 and the second pivot joint 80. More specifically, the foot pedal 82 controls the movement of the first portion 58 and the second portion 60 about the first pivot joint 74 and the second pivot joint 80, respectively.

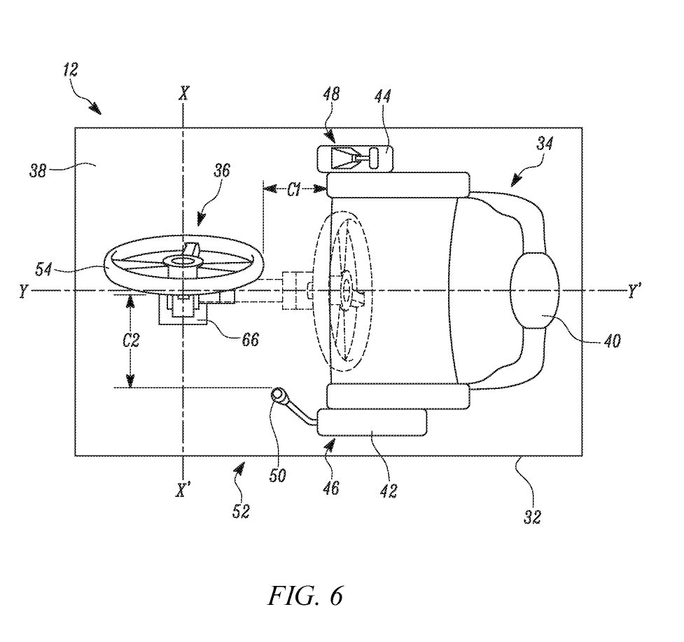

The foot pedal 82 is actuated by the operator to allow the movement of the first portion 58 and the second portion 60 about the first pivot axis X-X′ and the second pivot axis Y-Y′, thereby varying a first clearance “C1” between the operator seat 40 and the steering wheel 54 and a second clearance “C2” (shown in FIG. 6) between the joystick 50 and the steering wheel 54. When the foot pedal 82 is in an actuated position, the first pivot joint 74 and the second pivot joint 80 allow the movement of the first portion 58 and the second portion 60 of the steering column 30, respectively. More specifically, in the actuated position of the foot pedal 82, the operator moves the first portion 58 and the second portion 60 simultaneously about the first pivot joint 74 and the second pivot joint 80, respectively. Further, when the foot pedal 82 is in non-actuated position, the movement of the first portion 58 and the second portion 60 are restricted about the first pivot joint 74 and the second pivot joint 80, respectively.

As shown in FIGS. 3 and 4, the first portion 58 of the steering column 30 is pivotally movable between a first position “P1” and a second position “P2”. More specifically, the first portion 58 is movable between the first position “P1” and the second position “P2” about the first pivot axis X-X′. In the first position “P1”, the first portion 58 of the steering column 30 is inclined at a first angle “θ₁” with respect to a horizontal plane H-H′ defined by the first pivot joint 74. The horizontal plane H-H′ is parallel to the floor panel 38 of the cabin frame 32. In an example, the first angle “θ₁” may be a minimum angle at which the steering wheel 54 is positioned proximal to the operator seat 40, Further, the first angle “θ₁” may vary based on positioning of the operator seat 40 within the operator cabin 12.

During entry or exit of the operator into or from the operator cabin 12, the first portion 58 is moved from the first position “P1” to the second position “P2”. When the first portion 58 is moved form the first position “P1” to the second position “P2”, the steering wheel 54 moves away from the operator seat 40. In the second position “P2”, the first portion 58 of the steering column 30 is inclined at a second angle “θ₂” with respect to the horizontal plane H-H′. In an example, the second angle “θ₂” may be a maximum angle at which the steering wheel 54 is positioned proximal to a windshield of the operator cabin 12 such that the steering wheel 54 does not interfere with the windshield. An extent of the movement of the first portion 58 between the first position “P1” and the second position “P2” is defined based on a space between the operator seat 40 and the windshield of the operator cabin 12. The steering column 30 travels a first angular distance α, when the first portion 58 is pivotally moved from the first position “P1” to the second position “P2” about the first pivot axis X-X′. In an example, the first angular distance “α” may vary based on proximity of various components, such as the steering wheel 54, the joystick 50, and the operator seat 40, within the operator cabin 12.

Referring to FIGS. 3 to 5, the second portion 60 of the steering column 30 is pivotally movable between a third position “P3” and a fourth position “P4”. More specifically, the second portion 60 is pivotally movable between the third position “P3” and the fourth position “P4” about the second pivot axis Y-Y′.

In the third position “P3”, the second portion 60 of the steering column 30 is parallel to a vertical plane V-V′ defined by the first portion 58. When the second portion 60 is moved from the third position “P3” to the fourth position “P4”, the steering wheel 54 moves away from the doorway 52 of the operator cabin 12. In an example, the second portion 60 may be moved from the third position “P3” towards the doorway 52 of the operator cabin 12. In the fourth position “P4”, the second portion 60 of the steering column 30 is inclined at a third angle “θ₃” with respect to the vertical plane V-V′. In an example, the third angle “θ₃” may vary based on proximity of the doorway 52 relative to the base portion 56 of the steering column 30, More specifically, the third angle “θ₃” may vary based on proximity of various components, such as the steering wheel 54, the doorway 52, the joystick 50, and the operator seat 40, within the operator cabin 12. The extent of the movement of the second portion 60 between the third position “P3” and the fourth position “P4” is defined based on a space between the steering column 30 and surrounding operator controls, such as push-buttons, control levers, and control pedals, inside the operator cabin 12 of the machine 10.

### INDUSTRIAL APPLICABILITY

The present disclosure relates to the steering column 30 for the machine 10. The steering column 30 includes the first pivot joint 74 and the second pivot joint 80. The first pivot joint 74 allows movement of the first portion 58 of the steering column 30 between the first position “P1” and the second position “P2”. The second pivot joint 80 allows movement of the second portion 60 of the steering column 30 between the third position “P3” and the fourth position “P2”. The operator presses the foot pedal 82 to unlock the first pivot joint 74 and the second pivot joint 80, to manually move the first portion 58 and the second portion 60 about the first pivot axis X-X′ and the second pivot axis Y-Y′, respectively. In the actuated position of the foot pedal 82, the operator moves the first portion 58 between the first position “P1” and the second position “P2”, and the second portion 60 between the third position “P3” and the fourth position “P4”. When the operator releases the foot pedal 82, the first pivot joint 74 and the second pivot joint 80 get locked, thereby restricting the movement of the first portion 58 and the second portion 60 of the steering column 30.

Referring to FIG. 6, when the first portion 58 and the second portion 60 are in the second position “P2” and the fourth position “P4”, respectively, the second clearance “C2” is defined between the steering wheel 54 and the joystick 50. In an example, the first clearance “C1” and the second clearance “C2” may be varied by varying the second angle “θ₂” and the third angle “θ₃”, respectively. The first clearance “C1” and the second clearance “C2” improve the accessibility of the operator cabin 12 for the operator, thereby allowing the operator to effortlessly enter into and exit from the operator cabin 12. Also, the first clearance “C1” and the second clearance “C2” allow the operator to enter into and exit from the operator cabin 12 without any obstruction from various components, such as the steering wheel 54 and the joystick 50, disposed within the operator cabin 12.

The steering column 30 can be deployed in any type of machine used in construction applications, transportation applications, or any other application known in the art. Therefore, the steering column 30 has a wide range of application across industries. Moreover, the steering column 30 can be conveniently retrofittable with the machine 10. Therefore, the present disclosure offers the steering column 30 for the machine 10 that is simple, effective, easy to use, economical, and time saving.

What is claimed is:

1. A steering column for a machine, comprising:
abase portion coupled to a floor panel disposed within an operator cabin of the machine;
a first portion coupled to the base portion by a first pivot joint, and movable between a first position and a second position with respect to the floor panel about a first pivot axis; and
a second portion coupled to the first portion by a second pivot joint and a steering wheel, and movable between a third position and a fourth position with respect to the first portion about a second pivot axis, wherein the second pivot axis is perpendicular to the first pivot axis.

2. The steering column of claim 1, wherein an extent of the movement of the first portion between the first position and the second position is defined based on a space between an operator seat and a windshield of the operator cabin, and the movement of the second portion between the third position and the fourth position is defined based on a space between the steering column and surrounding operator controls inside the operator cabin of the machine.
